(19) United States
(12) Patent Application Publication
(10) Pub. No.: US 2002/0023067 A1
(43) Pub. Date: Feb. 21, 2002

(54) INTEGRATING A PRIMARY RECORD VIEWING SYSTEM WITH A DIFFERENT SECONDARY RECORD VIEWING SYSTEM

(76) Inventors: HARRY T. GARLAND, LOS ALTOS HILLS, CA (US); BERNARD L. HAYES, REDWOOD CITY, CA (US)

Correspondence Address: FITZPATRICK CELLA HARPER & SCINTO, 30 ROCKEFELLER PLAZA, NEW YORK, NY, 10112-3801, US

(21) Appl. No.: 09/096,599

(22) Filed: Jun. 12, 1998

(51) Int. Cl. G06F 7/00

(52) U.S. Cl. 707/1; 707/104.1

(57) ABSTRACT

A system (100) for integrating a primary record viewing system (101A) with a different secondary record viewing system (101B), such that a displayed primary record (120, 122) is automatically linked to a plurality of selectively displayable secondary records (120, 122), includes a primary record viewer (218, 244) for viewing a primary record (120, 122), a secondary record viewer (220, 246) for viewing a secondary record (120, 122), a primary client (216, 242) for accessing a primary database (110, 118), and an integration agent (222, 248) for searching a secondary database (110, 118) for at least one secondary record (120, 122) associated with the primary record (120, 122), linking the primary record (120, 122) to the at least one secondary record (120, 122), and selectively displaying the at least one secondary record (120, 122) on a display device (212, 236). A computer-implemented method includes searching (406, 434) a secondary database (110, 118) for at least one secondary record (120, 122) associated with the primary record (120, 122), linking (410) the primary record (120, 122) to the at least one secondary record (120, 122), and selectively displaying (424) the at least one secondary record (120, 122).

### BACKGROUND OF THE INVENTION

1. Field of the Invention

The present invention relates generally to medical imaging, and more particularly, to an integrated system and method for the display of radiological images and patient records.

2. Background Art

For many years, hospitals have compiled patient information in two distinct formats. One format is radiological images, which are obtained from a variety of diagnostic tools including computed tomography (CT), magnetic resonance (MR) imaging, computed radiography (CR), ultrasound (US), and nuclear medicine (NM). Such images are typically recorded on film or photographic plates and are subsequently reduced to a written report by a radiologist or other specialist.

The other format includes a variety of patient records, such as general patient information, insurance and billing records, radiological reports, charts, studies, and the like. Hospitals have been slow to implement electronic record storage, in part because of the difficulty of converting handwritten notes of doctors and nurses into digital form. As a result, with the exception of billing records, most patient records are still maintained in paper form in hospital filing cabinets.

In general, records and images are kept in separate locations of the hospital due to different storage and access requirements. However, this fact often means that the two formats are neither simultaneously available nor universally accessible. For example, after an image is read by the radiologist, it is generally not accessible to the attending physician, who is forced to rely solely on the radiologist's report. However, if the radiologist erred in reading the image, a misdiagnosis and incorrect treatment may result.

Similarly, the radiologist, while reading a radiological image, may not have access to patient records that are normally kept in another location of the hospital. Consequently, the radiologist is often limited to information provided by the patient's doctor, and may not be aware of pre-existing conditions or other valuable background information that may influence the interpretation of the image.

In light of these problems, there has been a long-standing need to provide both doctors and radiologists with increased access to the totality of patient information. Recent attempts have been made to address the problem by converting both formats into electronic form, with the goal of providing universal on-line access to patient information. However, the goal has been largely unsuccessful because the two formats are contained within substantially different and incompatible storage and retrieval systems.

For example, Canon Inc. has recently developed a system for acquiring x-ray images in digital form. Canon's Digital Radiography System (DRS) uses sophisticated sensor technology to digitally capture x-ray images, which can be archived and later transmitted to diagnostic viewers or printers. Similar fully digital systems are available for computed tomography, magnetic resonance imaging, and other acquisition modalities.

However, because of the large size of images generated by these diagnostic tools (sometimes exceeding 100 megabytes), special archival systems, such as picture archiving and communication systems (PACS), are often required. Typically, PACS archives employ multi-terabyte magneto-optical jukeboxes for long-term storage of images. Moreover, viewing terminals for PACS archives are generally workstation-class computers, having expensive, high-resolution monitors, and several megabytes of display memory. Interface hardware and software for such systems are generally proprietary, and available exclusively from the archive manufacturer.

In contrast, patient record systems have developed along markedly different lines, and are typically implemented on conventional, widely-available personal computers linked by the hospital's own internal network. In the case of handwritten records, conventional scanning devices are sometimes used to obtain digital copies of the record. Generally patient records are stored in standard relational databases on conventional database servers.

Parallel development, therefore, has resulted in separate and largely incompatible record viewing systems and image viewing systems. Due to these differences, interoperability has been a sought after but elusive goal. Recently, the Digital Imaging and Communications in Medicine (DICOM) standard was established to provide reliable and unambiguous transfer of radiological images among heterogeneous systems. For example, DICOM sets forth definitions, protocols, and services for transferring radiological images among acquisition modalities (e.g. CT scanners) and PACS archives, radiological displays, hard copy output devices, and the like.

Despite these advances, however, there is not, at present, a fully-integrated system for displaying patient records on imaging terminals and radiological images on patient record terminals. Where it is possible to share data between the two systems, interfaces are usually technical and cumbersome, and the user must explicitly perform searches on separate databases for each data format. A lack of an integrated solution has slowed adoption of digital imaging by hospitals and threatens future development.

Accordingly, what is needed is a system and method for seamlessly integrating record and image viewing systems, such that patient records may be displayed on imaging terminals and radiological images may be displayed on patient record terminals. What is also needed is an integrated system including an agent process that determines whether information in the opposite format is available for display. Moreover, what is needed is an integrated system that notifies a user in an intuitive and easily understood format that such information is available. What is also needed is an integrated system that retrieves and displays the information in response to a simple user command. Additionally, what is needed is an integrated system that converts the information to the proper format for display on a particular terminal.

### DISCLOSURE OF INVENTION

The present invention addresses the foregoing problems by providing an integrated medical imaging display system and method. According to one embodiment of the present invention, a patient record (120) is retrieved from a database (110) and displayed on a display device (212) of a patient record terminal (102). Thereafter, an integration agent (222) in the patient record terminal (102) searches an image archive (118) for radiological images (122) associated with the currently displayed record (120). If images (122) are found, a link object creator (304) creates a link object (600) for each image (122), displaying an associated image indicator (601) on the display device (212). When an indicator (601) is selected, the corresponding image (122) is copied from the archive (118) into the patient record terminal (102) and displayed using an image viewer (218).

According to another embodiment of the present invention, a radiological image (122) is retrieved from an archive (118) and displayed on a display device (236) of an image terminal (104). Thereafter, an integration agent (236) in the image terminal (104) searches a database (110) for patient records (120) associated with the currently displayed image (122). If records (120) are found, a link object creator (312) creates a link object (600) for each record (120), displaying an associated record indicator (602) on the display device (236). When an indicator (602) is selected, the corresponding record (120) is copied from the database (110) into the image terminal (104) and displayed using a record viewer (246).

### BRIEF DESCRIPTION OF THE DRAWINGS

These and other more detailed and specific objects and features of the present invention are more fully disclosed in the following specification, reference being had to the accompanying drawings, in which:

FIG. 1 is a high-level system diagram of the hardware components of an integrated medical imaging display system in accordance with a preferred embodiment of the present invention;

FIG. 2 is a block diagram of a patient record terminal 102 and an image terminal 104 in accordance with a preferred embodiment of the present invention;

FIG. 3 is a block diagram of two integration agents 222, 248 in accordance with a preferred embodiment of the present invention;

FIG. 4A is a flow diagram of a method for linking a record 102 to a plurality of images 122 in accordance with a preferred embodiment of the present invention;

FIG. 4B is a flow diagram of a method for displaying an image 122 on a patient record terminal 102 in accordance with a preferred embodiment of the present invention;

FIG. 4C is a flow diagram of a method for linking an image 122 to a plurality of records 120 in accordance with a preferred embodiment of the present invention;

FIG. 4D is a flow diagram of a method for displaying a record 120 on an image terminal 104 in accordance with a preferred embodiment of the present invention;

FIG. 5A is an exemplary screen shot of a patient record terminal 102 after a record search in accordance with a preferred embodiment of the present invention;

FIG. 5B is an exemplary screen shot of a patient record terminal 102 showing an expanded information window 504 in accordance with a preferred embodiment of the present invention;

FIG. 5C is an exemplary screen shot of a patient record terminal 102 showing an image 122 in accordance with a preferred embodiment of the present invention;

FIG. 5D is an exemplary screen shot of an image terminal 104 after an image search in accordance with a preferred embodiment of the present invention;

FIG. 5E is an exemplary screen shot of an image terminal 104 showing an expanded information window 504 in accordance with a preferred embodiment of the present invention;

FIG. 5F is an exemplary screen shot of an image terminal 104 showing a record 120 in accordance with a preferred embodiment of the present invention;

FIG. 6A is an illustration of a plurality of link objects 600 in accordance with a preferred embodiment of the present invention; and

FIG. 6B is an illustration of a link object 600 in accordance with a preferred embodiment of the present invention.

### DETAILED DESCRIPTION OF THE PREFERRED EMBODIMENTS

A preferred embodiment of the present invention is now described with reference to the Figures where like reference numbers indicate identical or functionally similar elements. Also in the Figures, the left most digit of each reference number corresponds to the Figure in which the reference number is first used.

System Architecture

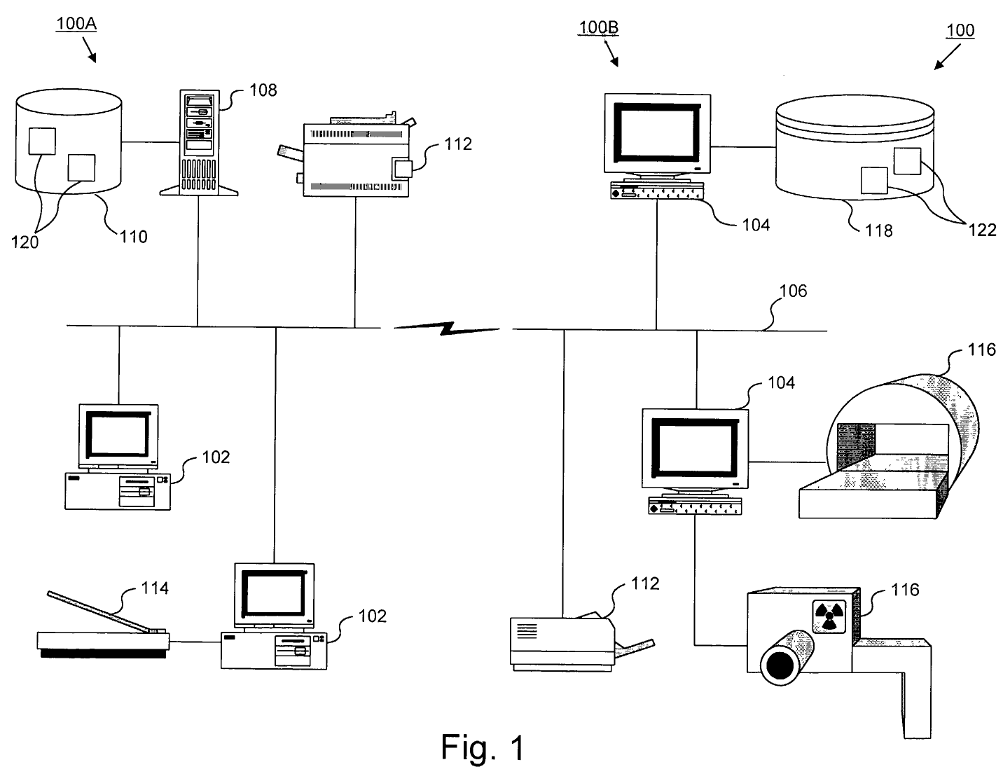

Referring now to FIG. 1, there is shown a high-level system diagram of the hardware components of an integrated medical imaging display system 100 including a patient record viewing system 101A and an image viewing system 101B in accordance with a preferred embodiment of the present invention. In one embodiment, the system 100 includes a plurality of patient record terminals 102 and image viewing terminals 104 (image terminals), each of which is coupled to a conventional computer network 106, such as an Ethernet. The patient record terminals 102 are preferably standard personal computers, such as IBM® PC compatibles, running under the Windows NT® operating system. One skilled in the art, however, will recognize that a variety of implementations are possible without departing from the spirit of the invention. In one embodiment, the patient record terminals 102 are primarily used to display a plurality of patient records 120 including, for example, general patient information, insurance and billing records, radiological reports, charts, studies, and the like.

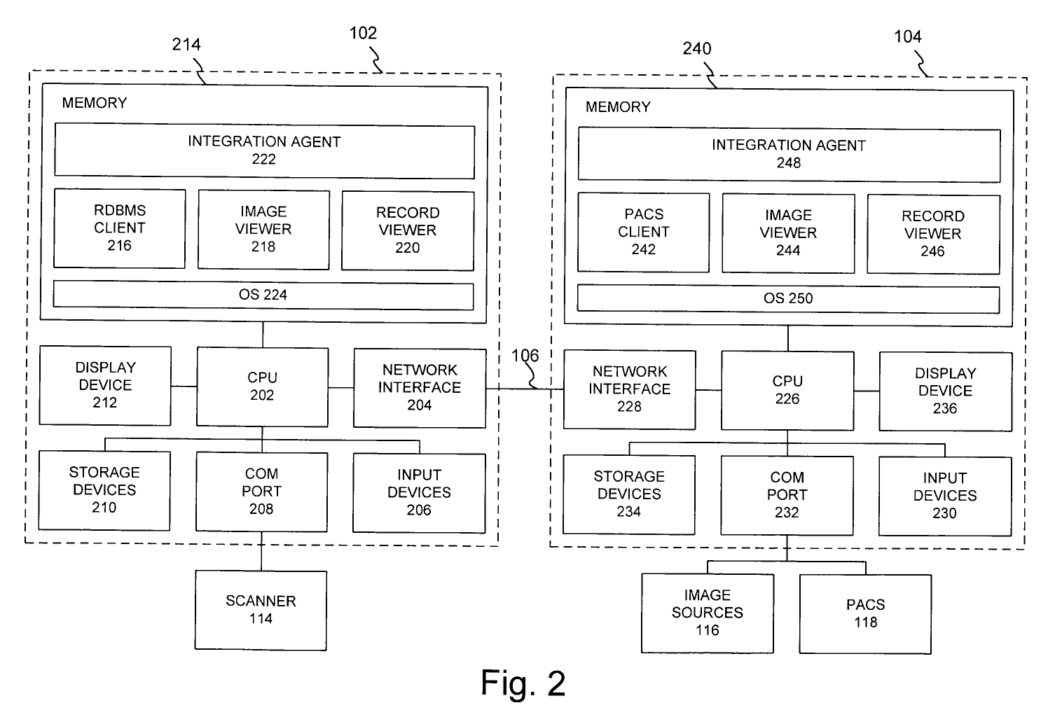

The image terminals 104 preferably include workstation-class computers, such as the Sun Ultra 60 manufactured by Sun Microsystems. Thus, in a preferred embodiment, the image terminals 104 include sufficient display memory and processing power to store and manipulate a plurality of radiological images 122. In addition, the image terminals 104 include professional quality monitors having display resolutions on the order of 1600×1200 pixels with 24 color bits per pixel for the display of the images 122. The patient record terminals 102 and the image terminals 104 are described in greater detail below with respect to FIG. 2.

Also coupled to the network 106 is a database server 108, which includes a patient records database 110. Preferably, the server 108 is a conventional database server with sufficient capacity to manage the records of a large hospital, employing symmetric multiprocessing (SMP) and a redundant array of inexpensive disks (RAID), and executing a multitasking operating system such as Windows NT or UNIX. The database 110 is managed by a standard relational database management system (RDBMS), a number of which are available from Oracle Corporation. The records 120 in the database 110 are accessed via a structured query language (SQL) or other conventional system.

Also coupled to the network 106 are a number of output devices or printers 112 for generating hard copies of the patient records 120 and the images 122. A variety of printers 112 may be used within the scope of the present invention, such as the HP 5 laser printer manufactured Hewlett-Packard. In the case of the images 122, specialized color laser or ink jet printers may be used, such as the Canon BJC-7004 Photo color ink jet printer, which provides 1200×600 dots per inch (dpi) resolution on plain paper.

In one embodiment, a patient record terminal 102 is coupled to a scanner 114. Preferably, the scanner 114 is a conventional flatbed scanner, such as the CanoScan 600 color scanner manufactured by Canon Inc., which provides 600 dots per inch (dpi) resolution with 24 bits per pixel. In a preferred embodiment, the scanner 114 is used to acquire a digital copies of written patient records 120 that are less amenable to data entry, such as nurses notes, physicians orders, and the like. Preferably, the acquired record 120 is subsequently compressed using JPEG or a similar compression algorithm and then filed in the database 110 by means of the server 108. In one embodiment, the record 120 is indexed in the database 110 according to a primary key such as the patient's name. social security number, or other unique identifier.

In one embodiment of the invention, an image terminal 104 is coupled to an image source 116 or “modality.” A number of image sources 116 may be used within the scope of the present invention, including computed tomography (CT), magnetic resonance (MR) imaging, computed radiogray (CR), ultrasound (US), and nuclear medicine (NM). Preferably, the image source 116 is adapted to provide a digital copy of the radiological image 122, rather than a film or hard copy version. For example, Canon's Digital Radiography System (DRS) captures x-ray images digitally, which may be stored and later transmitted to an image terminal 104 or printer 112. One skilled in the art, however, will recognize that film or hard copy images produced by a non-digitally-equipped modality may be digitally acquired via the scanner 114.

In one embodiment of the invention, an image terminal 104 is coupled to an image archive 118, such as a picture archiving and communication system (PACS), for storing radiological images 122 acquired by the image sources 116. A PACS archive 118 can provide storage capacities in excess of a terabyte (1000 gigabytes), which is advantageous since many CT and MR images can exceed 100 megabytes in size. Currently, PACS archives 118 are available from a number of manufacturers, including Lockheed Martin Corporation.

Although the image archive 118 of FIG. 1 is illustrated as being coupled to an image terminal 104, one skilled in the art will recognize that that the archive 118 may be coupled directly to a database server 108 or to the network 106 with appropriate interface hardware. In addition, one skilled in the art will recognize that a variety of image archives 118 other than a PACS may be used without departing from the spirit of the invention.

Referring now to FIG. 2, there is shown a block diagram of the patient record terminal 102 and the image terminal 104 in accordance with a preferred embodiment of the present invention. In one embodiment, the patient record terminal 102 includes a central processing unit 202 (CPU), a network interface 204, input devices 206, a communication port 208, storage devices 210, a display device 212, and a memory 214.

The CPU 202 executes software instructions and interacts with other system components to perform the methods of the present invention. In one embodiment, the CPU 202 is an Intel Pentium® II or similar processor. The network interface 204 connects the patient record terminal 102 to the network 106, and is preferably an Ethernet adapter or similar interface. The input devices 206, such as a mouse or keyboard, facilitate user control of the operation of system 100. The communication port 208, such as a conventional serial, parallel, or small computer serial interface (SCSI) port, is used to communicate with external devices such as the scanner 114. The storage devices 210 provide long term storage of data and software programs, and may be implemented as hard disk drives, flash memory, optical storage units, or other suitable mass storage devices. The display device 212 is an output device such as a cathode-ray tube (CRT) for the display of text and graphics under the control of the CPU 202.

The memory 214 is used to store record and image data, as well as software instructions to be executed by the CPU 202. Preferably, the memory 214 is implemented using a standard memory device, such as a random access memory (RAM). In one embodiment, the memory 214 includes a number of software objects or modules, including an RDBMS client 216, an image viewer 218, a record viewer 220, and an integration agent 222. Throughout this discussion, the foregoing modules are assumed to be separate functional units, but those skilled in the art will recognize that the functionality of various units may be combined and even integrated into a single software application or device. In addition, the memory 214 includes an operating system 224 for managing, and providing system resources to, the above-mentioned software objects or modules. Preferably, the operating system 214 is the Windows NT operating system available from Microsoft Corporation, although a variety of other operating systems, such as Windows 95, MacOS 8, and UNIX, may be used within the scope of the present invention.

In one embodiment, the RDBMS client 216 accesses the database 110 to retrieve and store patient records 120 using conventional techniques defined by the particular RDBMS. The image viewer 218 displays an image 122 on the display device 212, and may additionally convert the image's size and/or color depth, if necessary, to the requirements of the display device 212. In one embodiment, a single image viewer 218 is provided for viewing a plurality of image types, in which case the viewer 218 determines the type of the image 122 using conventional Windows NT file type registrations, or by detecting the image type from header information. In another embodiment, a plurality of image viewers 218 are provided, and one viewer 218 is selected by the integration agent 222 responsive to the image type.

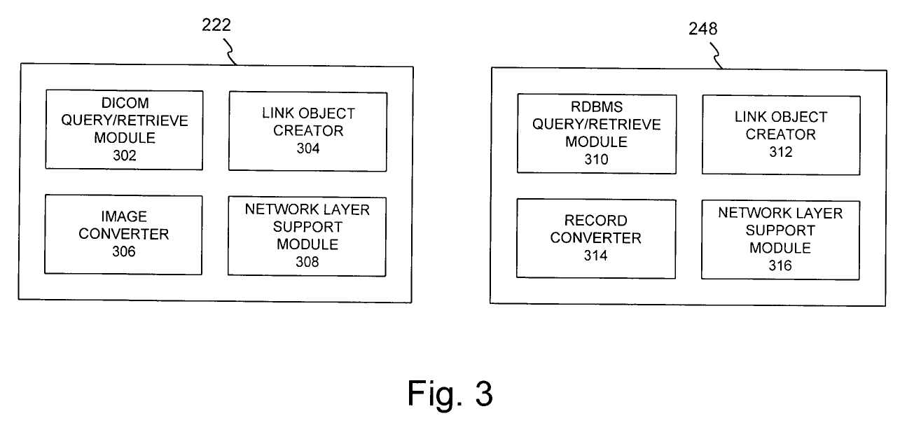

The record viewer 220 displays the current patient record 120 retrieved by the RDBMS client 216. As explained in greater detail below with reference to FIG. 3, the integration agent 222 searches the archive 118 for images 122 associated with the current patient record 120, allowing the user to selectively display the images 122 on the display device 212.

In one embodiment of the invention, the image terminal 104 includes a central processing unit 226 (CPU), a network interface 228, input devices 230, a communication port 232, storage devices 234, a display device 236, and a memory 240.

The CPU 226 executes software instructions and interacts with other system components to perform the methods of the present invention. In one embodiment, the CPU 226 is a Sun UltraSparc-II or a similar processor. The network interface 228 connects the image terminal 104 to the network 106, and is preferably an Ethernet adapter or similar interface. The input devices 230, such as a mouse or keyboard, facilitate user control of the operation of system 100. The communication port 232, such as a conventional serial, parallel, SCSI, or similar port, is used to communicate with external devices such as the image sources 116 and the image archive 118. The storage devices 234 provide long term storage of data and software programs, and may be implemented as hard disk drives, flash memory, optical storage units, or other suitable mass storage devices. The display device 236 is an output device such as a cathode-ray tube (CRT) for the display of text and graphics under the control of the CPU 202. Preferably, the display device 236 is a professional quality monitor having a pixel resolution on the order of 1600×1200 pixels with 24 color bits per pixel.

The memory 240 is used to store record and image data, as well as software instructions to be executed by the CPU 226. Preferably, the memory 240 is implemented using a standard memory device, such as a random access memory (RAM). In one embodiment, the memory 240 stores a number of software objects or modules, including an PACS client 242, an image viewer 244, a record viewer 246, and an integration agent 248. Throughout this discussion, the foregoing modules are assumed to be separate functional units, but those skilled in the art will recognize that the functionality of various units may be combined and even integrated into a single software application or device. Additionally, the memory 240 includes an operating system 250, for managing, and providing system resources to, the above-mentioned software objects or modules. Preferably, the operating system 250 is the Solaris 2.6 operating environment available from Sun Microsystems, although a variety of other operating systems, such as Windows NT, may be used within the scope of the present invention.

The PACS client 242 accesses the image archive 118 to load and store radiological images 122. Preferably, the PACS client 242 conforms to the DICOM 3.0 standard, implementing the query/retrieve, storage, and print management service classes. An overview of the DICOM 3.0 standard is provided in Implementation of the DICOM 3.0 Standard, published in 1994 by the Radiological Society of North America (RSNA), 2021 Spring Road, Suite 600, Oak Brook, Ill. 60521. The image viewer 244 displays an image 122 on the display device 236, and may additionally convert the image's size and/or color depth, if necessary, to the requirements of the display device 236.

The record viewer 246 displays a patient record 120 on the display device 236. In one embodiment, a single record viewer 246 is provided for viewing a plurality of record types, in which case the viewer 246 determines the type of the record 120 using conventional Windows NT file type registrations, or by detecting the record type from header information. In another embodiment, a plurality of record viewers 246 are provided, and one viewer 246 is selected by the integration agent 248 responsive to the record type.

As explained in greater detail below with reference to FIG. 3, the integration agent 248 searches the database 110 for records 120 associated with the current radiological image 122, allowing the user to selectively display such records 120 on the display device 236.

Referring now to FIG. 3, there is shown a block diagram of two integration agents 222, 248 in accordance with a preferred embodiment of the present invention. In one embodiment, the integration agents 222, 248 are processes running in a multitasking environment such as Windows NT or Solaris within the patient record terminals 102 and the image terminals 104, respectively.

The integration agent 222 preferably includes a DICOM query/retrieve module 302, a link object creator 304, an image converter 306, and a network layer support module 308. In one embodiment, the query/retrieve module 302 is derived from the query/retrieve service class defined in the DICOM 3.0 standard.

The query/retrieve module 302 is used to search the image archive 118 for images 122 associated with the currently displayed patient record 120. Preferably, the query is performed on a search term obtained from the patient record 120, such as a patient number or another unique identifier. The network layer support module 308 is used by the query/retrieve module 302 to communicate with the image archive 118. In a preferred embodiment, the transmission control protocol and Internet protocol (TCP/IP) are used by the network module 308 to facilitate communication over the network 106.

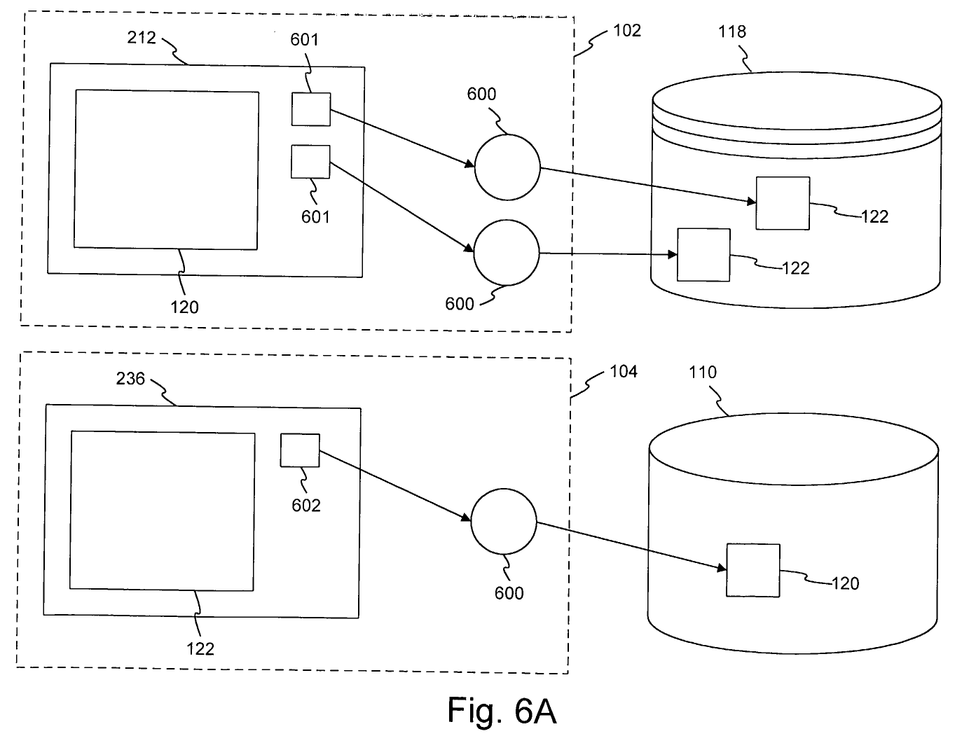

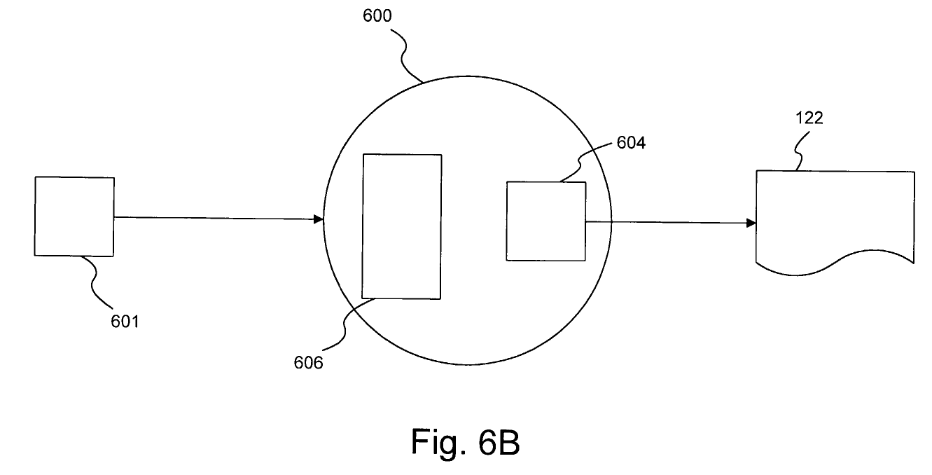

If any images 122 are found by the query/retrieve module 302, the link object creator 304 creates a link object 600 for each identified image 122, as illustrated in FIG. 6A. In one embodiment, a link object 600 is a C++ object that links an image indicator 601 on display device 212 with a radiological image 122 in the archive 118. The image indicator 601 is preferably a Windows icon or other suitable indicator such as a hyperlink. If the user later selects the indicator 601, the link object 600 includes control code to cause the query/retrieve module 302 to copy the associated image 122 into the patient record terminal 102, converting the image 122 if necessary via the image converter 306. The image 122 is then displayed on the display device 212 using the image viewer 218. In one embodiment, object linking and embedding (OLE) is used to launch the image viewer 218, which is a standard feature of the Microsoft Windows NT operating system.

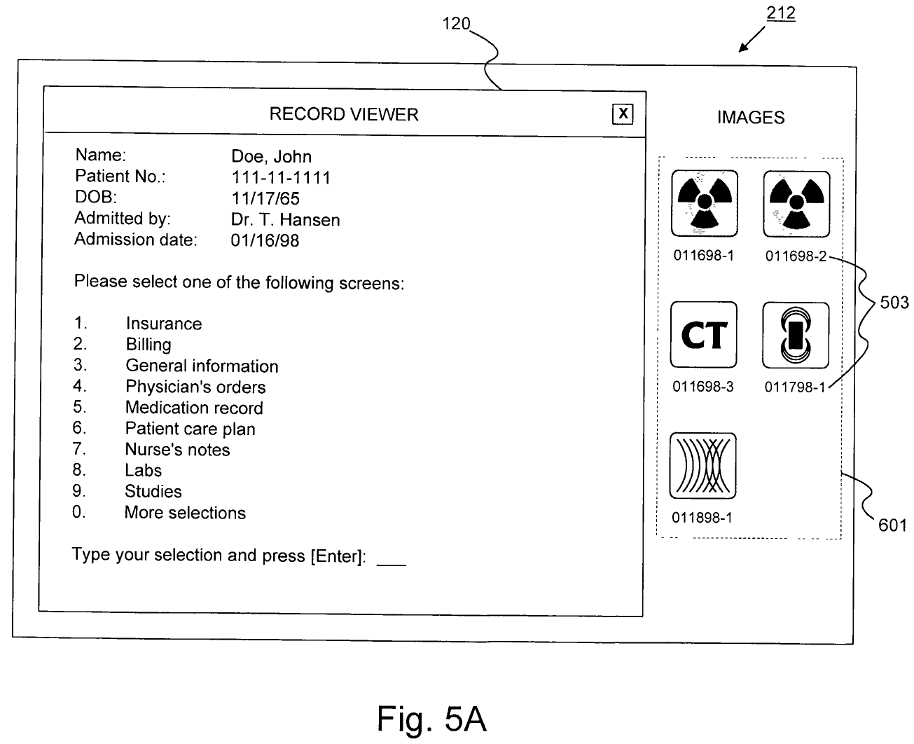

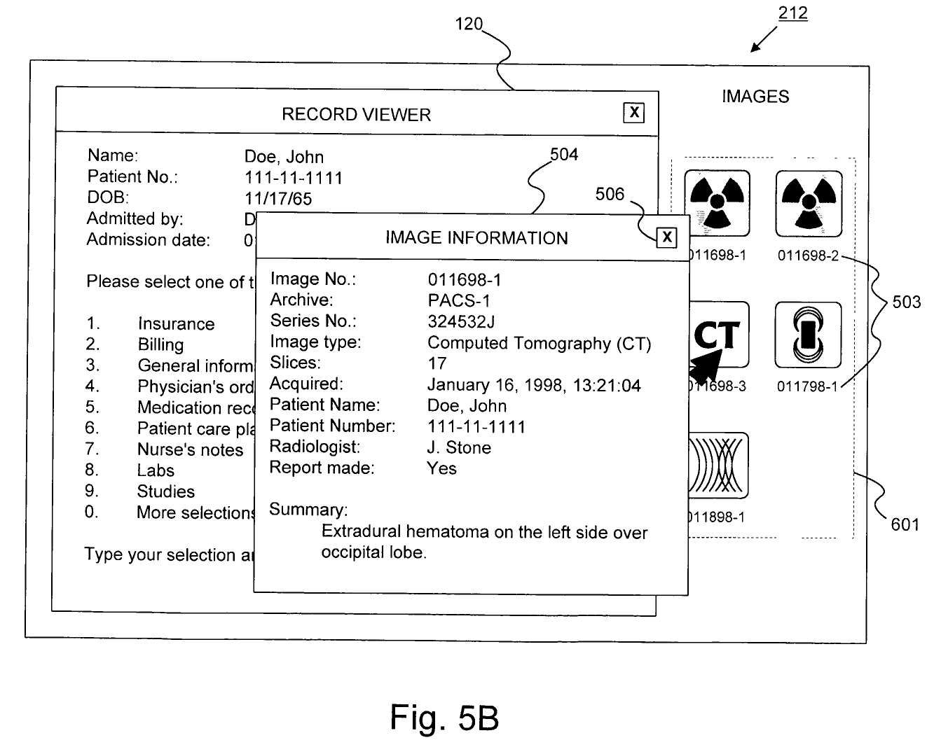

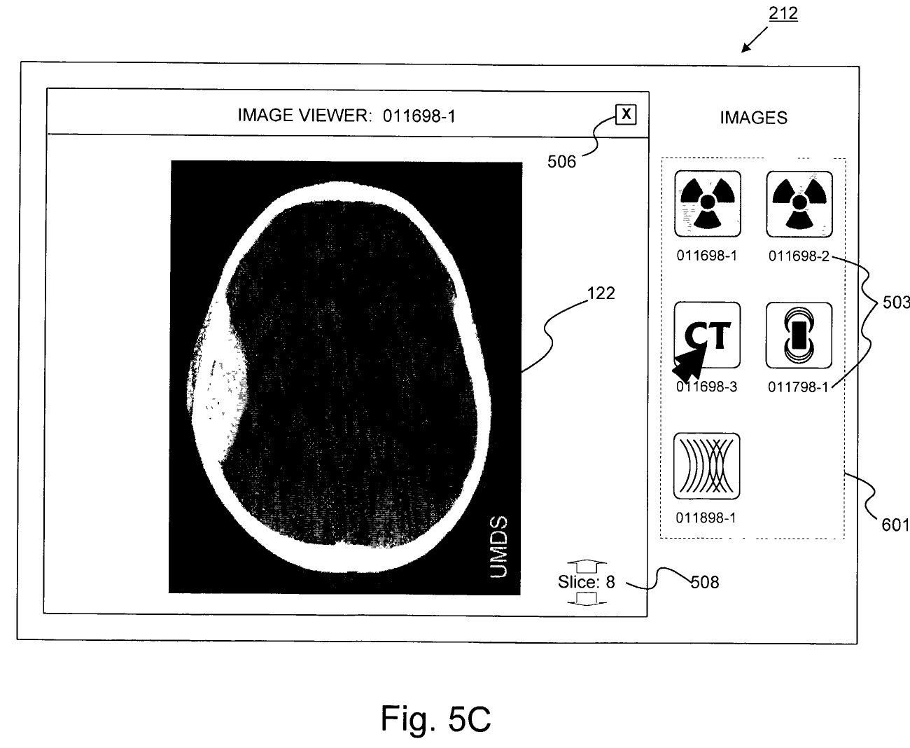

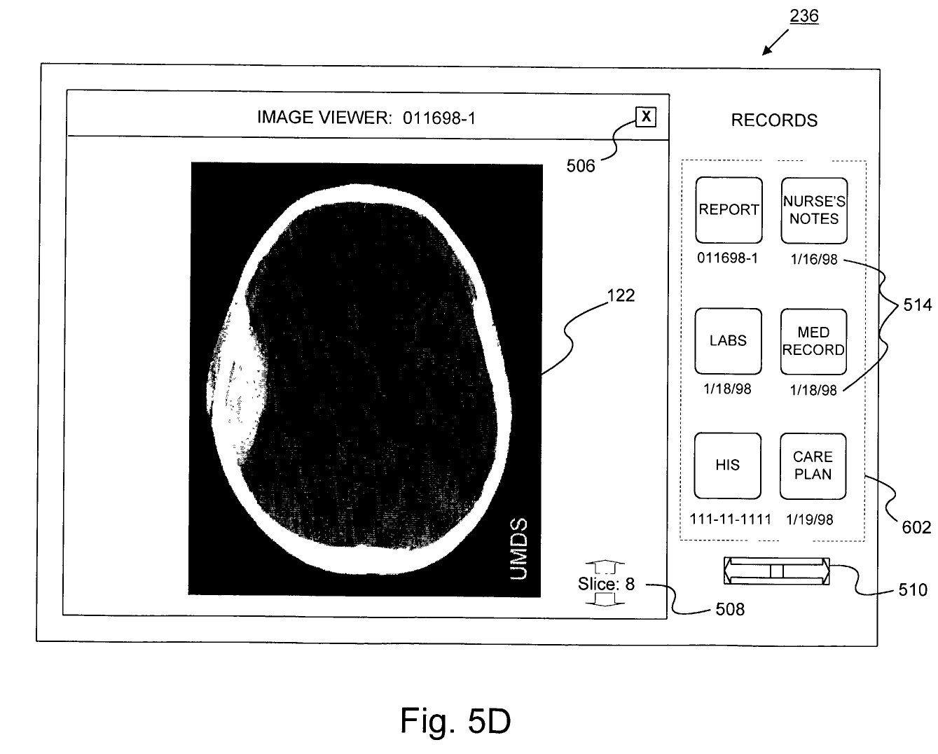

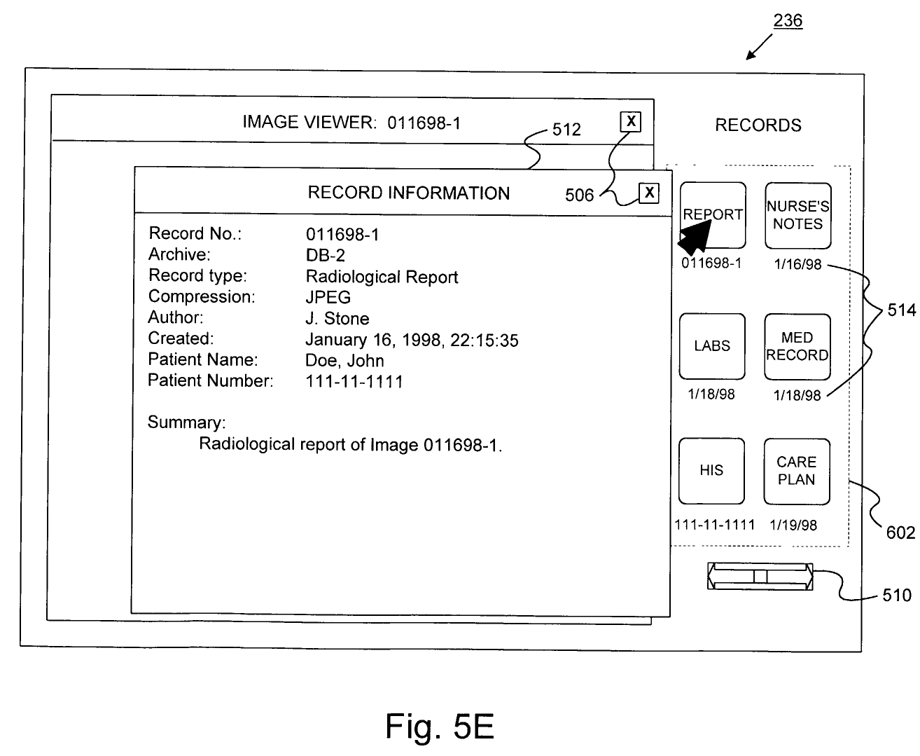

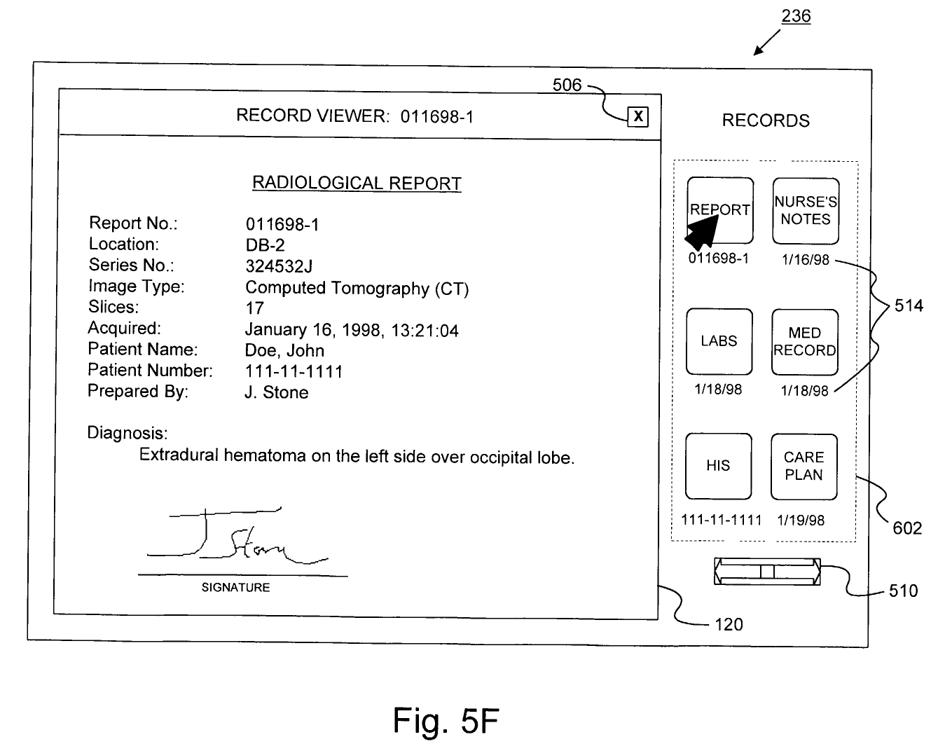

As shown in FIG. 6B, the link object 600 includes a reference pointer 604 that points to the associated image 122 (or record 120). In addition, the link object 600 includes an information store 606 that stores detailed information about the image 122, which, in one embodiment, is obtained from the archive 118 by the query/retrieve module 302 during a query. Such information may be later read from the object 600 by invoking an appropriate method. Although the amount of stored information will vary by implementation, a typical example is shown in FIG. 5B.

As further illustrated in FIG. 3, the integration agent 248 preferably includes a RDBMS query/retrieve module 310, a link object creator 312, and a network layer support module 314. The query/retrieve module 312 provides interface routines for accessing the database 110 and conforms to the specifications of the RDBMS provider. In operation, the query/retrieve module 310 searches the database 110 for patient records 120 associated with the currently displayed radiological image 122. Preferably, the query is performed on a search term associated with the image 122, such as a patient number or another unique identifier. The network layer support module 316 is used by query/retrieve module 310 to communicate with the database 110. In a preferred embodiment, TCP/IP or another standard network protocol is used to facilitate communication over the network 106.

If any patient records 120 are found by the query/retrieve module 310, the link object creator 312 creates a link object 600 for each identified record 120, as illustrated in FIG. 6A. In one embodiment, the link object 600 is a C++ object that links a record indicator 602 on display device 236 with a patient record 120 in the database 110. The record indicator 602 is preferably a Windows icon or other suitable indicator such as a hyperlink. If the user later selects the indicator 602, the link object 600 includes control code to cause the query/retrieve module 310 to copy the associated record 120 into the image terminal 104, converting the record 120 if necessary via the record converter 314. The record 120 is then displayed on the display device 236 using the record viewer 246. In one embodiment, object linking and embedding (OLE) is used to launch the record viewer 246, which is a standard feature of the Microsoft Windows NT operating system.

As shown in FIG. 6B, the link object 600 includes a reference pointer 604 that points to the associated record 120 (or image 122). In addition, the link object 600 includes an information store 606 that stores detailed information about the record 120, which, in one embodiment, is obtained from the database 110 by the query/retrieve module 310 during a query. Such information may be later read from the object 600 by invoking an appropriate method. Although the amount of stored information will vary by implementation, a typical example is shown in FIG. 5E.

Method of Operation

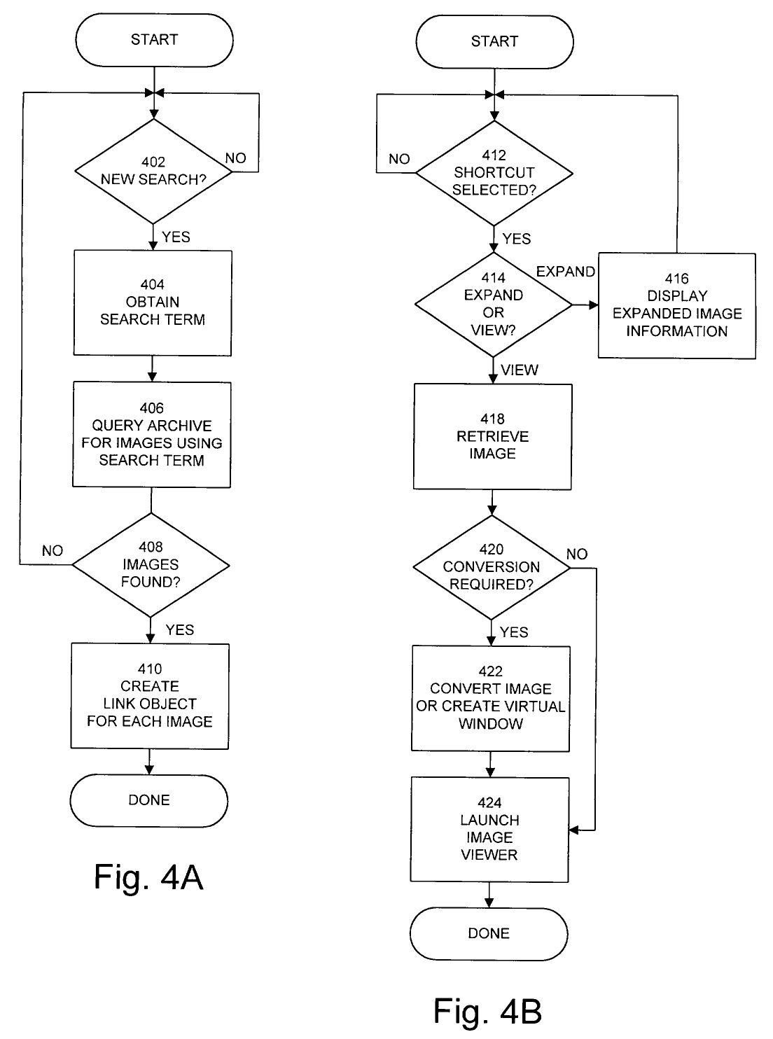

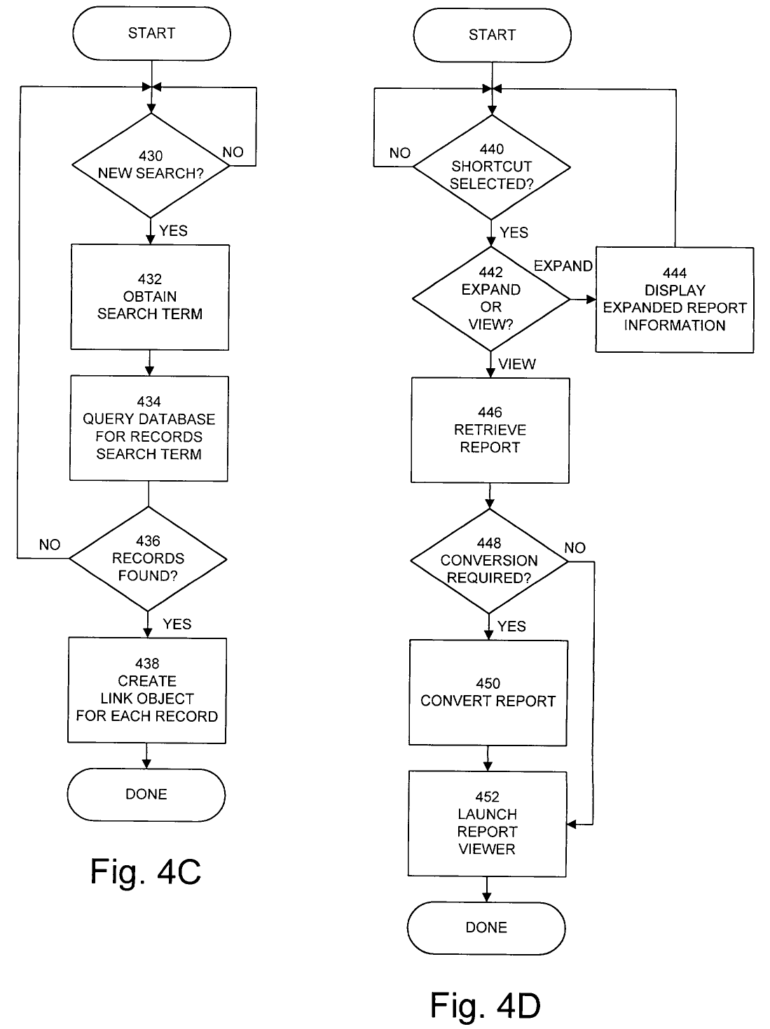

Referring now to FIG. 4A, there is shown a flow diagram of a method for linking a patient record 102 to a plurality of images 122 in accordance with a preferred embodiment of the present invention. The method begins by determining 402 whether a new search was just completed on the database 110, resulting in a patient record 120 being displayed on the display device 212. The primary function of the patient record terminal 102 is to retrieve and display patient records 120. Thus, a user enters a query via the patient record terminal 102 to search the database 110 by means of the RDBMS client 216. After a search is complete, the method proceeds to step 404; otherwise, the method waits at step 402 for a new search.

When the search is complete, a search term is obtained 404 from the currently displayed patient record 120, which will be used to query the image archive 118 for corresponding images 122. In one embodiment, the search term is the patient's name, social security number, or other unique identifier. Preferably, the integration agent 222 interacts with the RDBMS client 216 or the operating system 224 using standard techniques to obtain the search term from the currently displayed record 120.

After the search term is obtained, the query/retrieve module 302 queries 406 the image archive 118 for images 122 satisfying the search term. This is accomplished by invoking a method of the DICOM query/retrieve service class. Thereafter, a determination 408 is made whether any images 122 were found. If no images 122 were found, the method returns to step 402 to wait for another search.

If, however, at least one image 122 was found, the method continues by creating 412 a link object 600 for each identified image 122. In one embodiment, the link object 600 is a C++ object for linking an image 122 in the archive 118 to the currently displayed patient record 120. As illustrated in FIG. 6A, the link object 600 is represented graphically on the display device 212 as an image indicator 601, which is preferably a Windows icon or other suitable indicator.

Referring also to FIG. 5A, there is shown an exemplary screen shot of the patient record terminal 102 after completion of a record search. The located patient record 120 is shown in a first portion of the display 212, and may consist of a number of linked pages or screens. As the agent 222 finds each image 122 corresponding to the current record 120, an image indicator 601 is shown in a second portion of the display 212. In a preferred embodiment, the integration agent 222 is a multitasking process operating in the background to query the archive 118. Thus, the image indicators 601 are displayed asynchronously with the operation of the record viewer 220.

In a preferred embodiment, the image indicators 601 indicate the source 116 or modality from which the images 122 were obtained. For example, as shown in FIG. 5A, the image sources 116 may be indicated by symbolic icons for such modalities as nuclear medicine, computed tomography, magnetic resonance imaging, and ultrasound. A variety of other image sources 116 and associated icons are possible within the scope of the present invention. In addition, the image indicators 601 preferably include image identifiers 503, such as series numbers, ID codes, study numbers, dates, and the like, which identify the specific radiological image 122 in the archive 118. In one embodiment, the image identifiers 503 are implemented as names of Windows icons, which are maintained by the operating system 244.

Referring now to FIG. 4B, there is shown a flow diagram of a method for displaying an image 122 on a patient record terminal 102 in accordance with a preferred embodiment of the present invention. The method begins by determining 412 whether an image indicator 601 has been selected by means of the input device 206. Typically, the input device 206 is a mouse or keyboard, which controls a graphical user interface (GUI) to selectively interact with objects such as image indicators 601. If an indicator 601 is selected, the method proceeds to step 414; otherwise, the method returns to step 412 to wait for a selection.

The method continues in step 414 by determining whether to view the selected image 122 or to display expanded information about the image 122. One skilled in the art will recognize that the determination can be made in a number of ways, depending on the particular manner in which the indicator 601 was selected. For example, in one embodiment, double clicking on the indicator 601 with the left mouse button is an indication to view the image 122. Likewise, right clicking on the indicator 601 and selecting an “expand” option from a “popup” menu is an indication to display expanded information.

If the expand option is selected, the method continues with step 416 by opening an expanded information window 504 comprising additional information about the image 122, as shown in FIG. 5B. The expanded window 504 provides the user with more information without having to retrieve the image 122 from the archive 118. Preferably, the additional information is obtained by invoking a method in the corresponding link object 600. The expanded window 504 may be removed by clicking on a “close” button 506 or the like. Thereafter, the method returns to step 412 to wait for another selection.

If, however, the view option is selected, the method continues by retrieving the corresponding image 122 from the archive 118. This is accomplished by means of the query/retrieve module 302 which implements the DICOM query/retrieve service class. In a preferred embodiment, the image 122 is buffered in the storage device 210 prior to conversion or viewing.

After the image 122 is retrieved, a determination 420 is made whether the image 122 needs to be converted prior to viewing. As noted earlier, the display device 236 of an image terminal 104 is typically a professional, high-resolution monitor for displaying large, detailed images. Often, such display devices 236 have viewing dimensions exceeding 21 vertical inches and support pixel resolutions of 1600×1200 pixels or more. Record terminals 102, on the other hand, generally include conventional SVGA monitors having substantially less viewing area and supporting lower resolutions. Consequently, there is often a need to convert the radiological image 122 prior to viewing on a patient record terminal 102, such as by reducing the image's resolution or color depth, or both.

If a determination is made that the image 122 exceeds the capabilities of the display device 212, the image 122 is converted by the image converter 306 or by the image viewer 218 itself. Image processing techniques to reduce the resolution and/or color depth of an image 122 are well known in the art. In an alternative embodiment, the image 122 is not converted, but a portion of the image 122 is visible within a “virtual window” that may be panned responsive to user control to view the entire image 122. Virtual windowing is well known within the art, and is implemented in many video interfaces such as the Diamond Stealth 64 video adapter available from Diamond Multimedia, Inc.

If no conversion is required, or after the image 122 is converted, the method continues at step 424 by launching the image viewer 218 to display the image 122. In one embodiment, a single image viewer 218 is provided for viewing a plurality of image types, in which case the viewer 218 determines the type of the image 122 using conventional Windows NT file type registrations, or by detecting the type from header information. In another embodiment, a plurality of image viewers 218 are provided, and one viewer 218 is selected by the integration agent 222 responsive to the image type specified in the associated link object 600.

In one embodiment, the format of the image 122 varies according to the particular image source 116, in which case the decoding algorithm implemented by the viewer 218 is defined by the modality manufacturer. Alternatively, a single image format is used, such as the graphics interchange format (GIF) or tagged interchange file format (TIFF), both of which are well known in the art of image processing. In some cases, a compressed format such as JPEG may be used, although “lossy” algorithms may result in unacceptable image degradation.

Referring now to FIG. 5C, there is shown an exemplary screen shot of the patient record terminal 102 showing the image 122 corresponding to the selected indicator 601. In a preferred embodiment, the image viewer 218 provides zoom and pan functionality, and may include the capacity to add annotations to the radiological image 122. Additionally, for images 122 comprising multiple slices, such as those produced in computed tomograhy (CT), the image viewer 218 provides a paging mechanism 508 for selectively displaying each of the slices. After the viewing session is complete, the image viewer 218 may be removed by clicking on a “close” button 506, after which the current record 120 will again be displayed.

Referring now to FIG. 4C, there is shown a flow diagram of a method for linking an image 122 to a plurality of records 120 in accordance with a preferred embodiment of the present invention. The method begins by determining 430 whether a new search was just completed on the image archive 118, resulting in an image 122 being displayed on the display device 236. The primary function of the image terminal 104 is to retrieve and display radiological images 122. Thus, a user enters a query via the image terminal 104 to search the image archive 118 by means of the client 242. After a search is complete, the method proceeds to step 432; otherwise, the method waits at step 430 for a new search.

When the search is complete, a search term is obtained 432 from the currently displayed image 122, which will be used to query the database 110 for corresponding patient records 120. In one embodiment, the search term is the patient's name, social security number, or other unique identifier. Preferably, the integration agent 222 interacts with the client 242 or the operating system 250 using standard techniques to obtain the search term from the currently displayed image 122.

After the search term is obtained, the query/retrieve module 310 queries 434 the database 110 for records 120 satisfying the search term. Thereafter, a determination 436 is made whether any records 120 were found. If no records 120 were found, the method returns to step 430 to wait for another search.

If, however, at least one patient record 120 was found, the method continues by creating 438 a link object 600 for each identified record 120. In one embodiment, a link object 600 is a C++ object for linking a patient record 120 in the database 110 to the currently displayed image 122. As illustrated in FIG. 6A, a link object 600 is represented graphically on the display device 236 as a record indicator 602, which is preferably a Windows icon or other suitable indicator.

Referring also to FIG. 5D, there is shown an exemplary screen shot of the image terminal 104 after an image search. The located image 122 is shown in a first portion of the display 236, and may consist of a number of image slices as noted earlier. As each record 120 corresponding to the current image 120 is found by the agent 248, a record indicator 602 is shown in a second portion of the display 236. In a preferred embodiment, the integration agent 248 is a multitasking process operating in the background to query the database 110. Thus, the record indicators 602 are displayed asynchronously with the operation of the image viewer 244. If more record indicators 602 are created than may be simultaneously displayed, a slider 510 or similar mechanism is activated to allow selective display of a portion of the indicators 602. A similar mechanism is provided for the selective display of the image indicators 601.

In a preferred embodiment, the record indicators 602 indicate the type of the record 120. For example, as shown in FIG. 5D, the indicators 602 may include descriptive icons for such record types as reports, nurse's notes, lab results, medication records, hospital information system (HIS) records, and care plans. A variety of other records and associated icons are possible within the scope of the present invention. In addition, the record indicators 602 preferably include record identifiers 514, such as dates, series numbers, patient identification numbers, study numbers, and the like, which identify the specific patient record 120 in the database 110.

Referring now to FIG. 4D, there is shown a flow diagram of a method for displaying a record 120 on an image terminal 104 in accordance with a preferred embodiment of the present invention. The method beings by determining 440 whether a record indicator 602 has been selected by means of the input device 230. Typically, the input device 230 is a mouse or keyboard, which controls a graphical user interface (GUI) to selectively interact with objects such as record indicators 602. If an indicator 602 is selected, the method proceeds to step 442; otherwise, the method returns to step 440 to wait for a selection.

The method continues in step 442 by determining whether to view the selected patient record 120 or to display expanded information about the record 120. One skilled in the art will recognize that the determination can be made in a number of ways, depending on the particular manner in which the indicator 602 was selected. For example, in one embodiment, double clicking on the indicator 602 with the left mouse button is an indication to view the record 120. Likewise, right clicking on the indicator 602 and selecting an “expand” option from a “popup” menu is an indication to display expanded information.

If the expand option is selected, the method continues with step 444 by opening an expanded information window 512 comprising additional information about the patient record 120 as shown in FIG. 5E. Preferably, the additional information is obtained by invoking a method in the corresponding link object 600. The expanded window 512 may be removed by clicking on a “close” button 506 or the like. Thereafter, the method returns to step 412 to wait for another selection.

If, however, the view option is selected, the method continues by retrieving the corresponding patient record 120 from the database 110. This is accomplished by means of the query/retrieve module 310, which implements the appropriate RDBMS functionality. In a preferred embodiment, the record is buffered in the storage device 210 prior to conversion or viewing.

After the record 120 is retrieved, a determination 420 is made whether the record 120 needs to be converted prior to viewing. A number of conversions may be required within the scope of the present invention. For example, in some instances, patient records 120 that are digitized images of written reports may be too small or difficult to read when displayed on the higher resolution display devices 236 of image terminals 104. In such cases, the record converter 314 converts 450 the record 120 by expanding its size, changing its aspect ratio, or performing other necessary modifications to facilitate viewing.

If no conversion is required, or after the record 120 is converted, the method continues at step 452 by launching the record viewer 246 to display the patient record 122. In one embodiment, a single record viewer 246 is provided for viewing a plurality of record types, in which case the viewer 246 determines the type of the record 120 using conventional Windows NT file type registrations, or by detecting the type from header information. In another embodiment, a plurality of record viewers 246 are provided, and one viewer 246 is selected by the integration agent 248 responsive to the image type specified in the associated link object 600. Referring now to FIG. 5F, there is shown an exemplary screen shot of an image terminal 104 showing the patient record 120 corresponding to the selected record indicator 602. In a preferred embodiment, the record viewer 246 provides zoom and pan functionality, and may include the capacity to edit and/or add annotations to the record 120. After the viewing session is complete, the record viewer 246 may be removed by clicking on a “close” button 506, after which the current image 122 will again be displayed.

The above description is included to illustrate the operation of the preferred embodiments and is not meant to limit the scope of the invention. The scope of the invention is to be limited only by the following claims. From the above discussion, many variations will be apparent to one skilled in the art that would yet be encompassed by the spirit and scope of the present invention.

What is claimed is:

1. A computer-implemented method for integrating a primary record viewing system with a different secondary record viewing system, such that a displayed primary record is automatically linked to a plurality of selectively displayable secondary records, the method comprising the steps of:
displaying a primary record retrieved from a primary database;
searching a secondary database for at least one secondary record associated with the primary record;
linking the primary record to the at least one secondary record; and
selectively displaying the at least one secondary record.

2. The method of claim 1, wherein the primary record is a patient record, the primary database is a patient records database, the secondary record is a radiological image, and the secondary database is an image archive.

3. The method of claim 1, wherein the primary record is a radiological image, the primary database is an image archive, the secondary record is a medical record, and the secondary database is a patient records database.

4. The method of claim 1, wherein the searching step comprises:
obtaining a search term from the primary record; and
performing a query on the secondary database using the search term.

5. The method of claim 1, wherein the linking step comprises:
for each secondary record associated with the primary record,
creating a link object;
displaying an indicator in conjunction with the primary record; and
linking the indicator to the secondary record via the link object.

6. The method of claim 5, wherein the link object comprises:
a reference pointer for pointing to the secondary record;
an information store for describing the secondary record; and
control code for causing the secondary record to be retrieved and displayed.

7. The method of claim 5, wherein the indicator is an iconized object in a graphical user interface.

8. The method of claim 7, wherein the indicator indicates a record type, and further comprises a record identifier that identifies a specific secondary record in the secondary database.

9. The method of claim 1, wherein the selectively displaying step comprises:
responsive to a selection of an indicator using a first command,
retrieving the secondary record associated with the indicator:
selectively converting the secondary record for display on a specific output device; and
launching a secondary record viewer to view the secondary record.

10. The method of claim 9, wherein the launching step is performed via object linking and embedding (OLE).

11. The method of claim 1, wherein the selectively displaying step comprises: responsive to a selection of an indicator using a second command,
retrieving expanded information about the selected secondary record from an information store in an associated link object; and
displaying the expanded secondary record information.

12. A system for integrating a primary record viewing system with a different secondary record viewing system, such that a displayed primary record is automatically linked to a plurality of selectively displayable secondary records, the system comprising:
an integration agent for searching a secondary database for at least one secondary record associated with the primary record, linking the primary record to the at least one secondary record, and selectively displaying the at least one secondary record.
a primary record viewer, coupled to the integration agent, for viewing the primary record;
a secondary record viewer, coupled to the integration agent, for viewing the secondary record; and
a primary client, coupled to the integration agent, for retrieving a primary record from a primary database.

13. The system of claim 12, wherein the primary record is a patient record, the primary database is a patient records database, the secondary record is a radiological image, and the secondary database is an image archive.

14. The system of claim 12, wherein the primary record is a radiological image, the primary database is an image archive, the secondary record is a medical record, and the secondary database is a patient records database.

15. The system of claim 12, wherein the integration agent comprises:
a query/retrieve module for querying a secondary database and retrieving a selected secondary record; and
a link object creator, coupled to the query/retrieve module, for creating a link object to link each secondary record associated with the primary record with an indicator associated with the primary record.

16. The system of claim 15, wherein the query/retrieve module implements the query/retrieve service class defined in the Digital Imaging and Communications in Medicine (DICOM) standard.

17. The system of claim 15, further comprising:
an image converter, coupled to the query/retrieve module, for selectively converting a record to the display requirements of an output device.

18. The system of claim 12, wherein the link object comprises:
a reference pointer for pointing to the secondary record;
an information store for describing the secondary record; and
control code for causing the secondary record to be retrieved and displayed.

19. The system of claim 12, wherein the indicator is an iconized object in a graphical user interface.

20. A computer-readable medium having computer-readable program code devices embodied therein for integrating a primary record viewing system with a different secondary record viewing system, such that a displayed primary record is automatically linked to a plurality of selectively displayable secondary records, the computer-readable medium comprising:
computer-readable program code devices configured to display a primary record retrieved from a primary database;
computer-readable program code devices configured to search a secondary database for at least one secondary record associated with the primary record;
computer-readable program code devices configured to link the primary record to the at least one secondary record; and
computer-readable program code devices configured selectively display the at least one secondary record.

21. The computer-readable medium of claim 20 wherein the computer-readable program code devices configured to search the secondary database comprise:
computer-readable program code devices configured to obtain a search term from the primary record; and
computer-readable program code devices configured to perform a query on the secondary database using the search term.

22. The computer-readable medium of claim 20 wherein the computer-readable program code devices configured to link the primary record to the at least one secondary record comprise:
computer-readable program code devices configured, for each secondary record associated with the primary record, to:
create a link object;
display an indicator in conjunction with the primary record; and
link the indicator to the secondary record via the link object.

23. The computer-readable medium of claim 20 wherein the computer-readable program code devices configured to selectively display the at least one secondary record comprise:
computer-readable program code devices configured, responsive to a selection of an indicator using a first command, to:
retrieve the secondary record associated with the indicator;
selectively convert the secondary record to match a specific output device; and
launch a secondary record viewer to view the secondary record.

24. The computer-readable medium of claim 20 wherein the computer-readable program code devices configured to selectively display the at least one secondary record comprise:
computer-readable program code devices configured, responsive to a selection of an indicator using a second command, to:
retrieve expanded information about the selected secondary record from an information store in an associated link object; and
display the expanded secondary record information.
